(19) United States
(12) Patent Application Publication
(10) Pub. No.: US 2025/0306553 A1
(43) Pub. Date: Oct. 2, 2025

(54) SMART CABINET SYSTEM AND METHOD THEREOF

(71) Applicant: HCL Technologies Limited, New Delhi (IN)

(72) Inventors: Prakash Ghosh, Bangalore (IN); Santosh V. Pujer, Bangalore (IN)

(21) Appl. No.: 19/010,045

(22) Filed: Jan. 5, 2025

(30) Foreign Application Priority Data
Mar. 30, 2024 (IN) 202411026723

(51) Int. Cl. G05B 19/042

(52) U.S. Cl. CPC G05B 19/042; G05B 2219/25257

(57) ABSTRACT

This disclosure relates to smart cabinet system and method for smart cabinet. The smart cabinet system includes tagged container including predefined initial weight of item, and tray assembly. The tray assembly further includes sensor tray including first tag sensor, and cabinet tray including second tag sensor and weighing sensor. The smart cabinet system further includes server configured to receive first identification data signal corresponding to the tagged container from the first tag sensor; store registration details of the tagged container to obtain registered container; receive second identification data signal from the second tag sensor and current weight data signal from the weighing sensor, corresponding to the registered container; determine current quantity of the item within the registered container based on comparison between the predefined initial weight of the item and the current weight data signal; and determine time remaining from the expiration date of the item.

### TECHNICAL FIELD

This disclosure relates generally to the kitchen commodity management system, and more particularly to a smart cabinet system and method thereof.

### BACKGROUND

Currently, kitchen commodities (such as grains, spices, and pouch items) are not efficiently tracked in households. People have to manually monitor levels (i.e., amount left) of such commodities and also have to keep a track of approaching expiry dates of the commodities. It is a very common scenario during cooking to find that an item has run out of stock right at the moment when it is needed.

It is also very easy to lose track of the expiry dates of multiple commodities. Losing track of expiry dates may also lead to wastage of the commodities when the commodities are past their expiry dates prior to complete consumption. Further, consumption of commodities beyond their expiry dates is not healthy. Thus, manual monitoring of the commodities is time-consuming, tedious, and prone to errors.

The present invention is directed to overcome one or more limitations stated above or any other limitations associated with the known arts.

### SUMMARY

In one embodiment, a smart cabinet system is disclosed. In one example, the smart cabinet system may include a tagged container. The tagged container may include a predefined initial weight of an item. The smart cabinet system may further include a tray assembly. The tray assembly may include a sensor tray. The sensor tray may include a first tag sensor. The tray assembly may further include a cabinet tray. The cabinet tray may include a second tray sensor and a weighing sensor. The smart cabinet system may further include a server. The server may be configured to receive a first identification data signal corresponding to the tagged container from the first tag sensor. The server may be further configured to store registration details of the tagged container based on the first identification data signal to obtain a registered container. It should be noted that the registration details may include item name, expiration date of the item, and the predefined initial weight of the item. The server may be further configured to receive a second identification data signal from the second tag sensor and a current weight data signal from the weighing sensor, corresponding to the registered container. The server may be further configured to determine a current quantity of the item within the registered container based on a comparison between the predefined initial weight of the item and the current weight data signal. The server may be further configured to determine time remaining from the expiration date of the item based on the expiration date of the item.

In one embodiment, a method for a smart cabinet system is disclosed. In one example, the method may include receiving a first identification data signal corresponding to the tagged container from the first tag sensor. A smart cabinet system may include a tagged container. The tagged container may include a predefined initial weight of an item. The smart cabinet system may further include a tray assembly. The tray assembly may include a sensor tray. The sensor tray may include a first tag sensor. The tray assembly may further include a cabinet tray. The cabinet tray may include a second tag sensor and a weighing sensor. The method may further include storing registration details of the tagged container based on the first identification data signal to obtain a registered container. It should be noted that the registration details may include item name, expiration date of the item, and the predefined initial weight of the item. The method may further include receiving a second identification data signal from the second tag sensor and a current weight data signal from the weighing sensor, corresponding to the registered container. The method may further include determining a current quantity of the item within the registered container based on a comparison between the predefined initial weight of the item and the current weight data signal. The method may further include determining time remaining from the expiration date of the item based on the expiration date of the item.

It is to be understood that both the foregoing brief description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of an exemplary smart cabinet system, in accordance with some embodiments of the present disclosure.

FIG. 2 illustrates a functional block diagram of an exemplary cabinet tray, in accordance with some embodiments of the present disclosure.

FIGS. 3A-C illustrate various views of an exemplary cabinet tray, in accordance with some embodiments of the present disclosure.

FIGS. 4A and 4B illustrate various views of another exemplary cabinet tray, in accordance with some embodiments of the present disclosure.

FIG. 4C illustrates a mechanism to determine weight of a tagged container using the cabinet tray of FIGS. 4A and 4B, in accordance with some embodiments of the present disclosure.

FIG. 5 illustrates yet another exemplary cabinet tray, in accordance with some embodiments of the present disclosure.

FIG. 6 illustrates a functional block diagram of an exemplary sensor tray, in accordance with some embodiments of the present disclosure.

FIGS. 7A-C illustrate various views of an exemplary sensor tray, in accordance with some embodiments of the present disclosure.

FIG. 8 illustrates another exemplary sensor tray, in accordance with some embodiments of the present disclosure.

FIG. 9 illustrates an exemplary RFID/QR tagged container, in accordance with some embodiments of the present disclosure.

FIG. 10 illustrates an exemplary NFC neodymium magnet-tagged container, in accordance with some embodiments of the present disclosure.

FIGS. 11A-D illustrate various views of an exemplary NFC strain-tagged container, in accordance with some embodiments of the present disclosure.

FIGS. 12A-C illustrate exemplary Graphical User Interfaces (GUIs) corresponding to a smart cabinet system, in accordance with some embodiments of the present disclosure.

FIG. 13 illustrates a flow diagram of an exemplary process implemented by a smart cabinet system, in accordance with some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

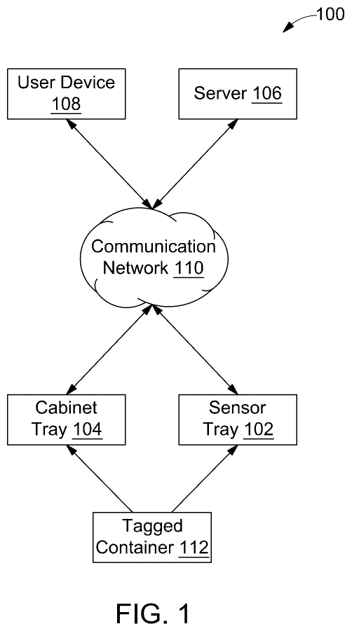

Referring now to FIG. 1, an exemplary smart cabinet system 100 is illustrated via a block diagram, in accordance with some embodiments of the present disclosure. The smart cabinet system 100 may include a sensor tray 102, a cabinet tray 104, a server 106, and a user device 108 communicatively coupled with each other through a communication network 110. The communication network 110, for example, may be any wired or wireless communication network and the examples may include, but are not limited to, the Internet, Wireless Local Area Network (WLAN), Wi-Fi, Long Term Evolution (LTE), Worldwide Interoperability for Microwave Access (WiMAX), and General Packet Radio Service (GPRS).

The sensor tray 102 and the cabinet tray 104 may be collectively referred to as a tray assembly. The smart cabinet system may be provided with a tagged container 112 configured to store an item (such as, kitchen commodity). The tagged container 112 may include an identification tag. By way of an example, the identification tag may be one of a Radio Frequency Identification (RFID) tag, a Near-Field Communication (NFC) neodymium magnet tag, a barcode tag, or a Quick Response (QR) code tag. The identification tag may be attached on external surface of the tagged container 112 (for example, on a bottom surface or on a periphery of the tagged container 112). The tagged container 112 may contain a predefined initial weight of an item. The item may include, for example, grain (wheat, barley, pulse, corn, rice, oats, etc.), spices (black pepper, garlic powder, cumin, cinnamon, chili powder, etc.), oils (mustard oil, olive oil, ghee, vegetable oil, hair oil, etc.), sugar, salt, dry fruits, flour, detergent powder, or any other item that may be stored. The tagged container 112 may be available in various shapes (e.g., rectangular, circular, square, etc.), sizes, and material (e.g., plastics, fiber, glass, etc.).

The sensor tray 102 may include a first tag sensor. By way of an example, the first tag sensor may be, but not limited to, an RFID antenna, an NFC sensor, a barcode scanner, a QR code sensor, and the like. The sensor tray 102 may be configured to register the tagged container 112 with the smart cabinet system 100 for the first time. This may be achieved by sending a first identification data signal corresponding to the tagged container 112 to the server 106 from the first tag sensor. The server 106 may store registration details of the tagged container 112 based on the first identification data signal to obtain a registered container. The registration details may include item name, expiry date of the item, registration number, and the like.

In an exemplary scenario, a user may want to register the tagged container 112 for the first time with the smart cabinet system 100. The tagged container 112 may include an identification tag on a bottom surface of the tagged container. The sensor tray 102 may include a scanning area on a top surface where one or more first tag sensors are positioned. The user may place the tagged container 112 on the scanning area or may bring the tagged container 112 in proximity to the scanning area such that the identification tag is recognized (i.e., a first identification data signal corresponding to the tagged container 112 is generated by the first tag sensor). The first tag sensor may then send the identification signal to the server 106 through the communication network 110. The tagged container 112 may then be registered by the server 106 based on the identification data signal.

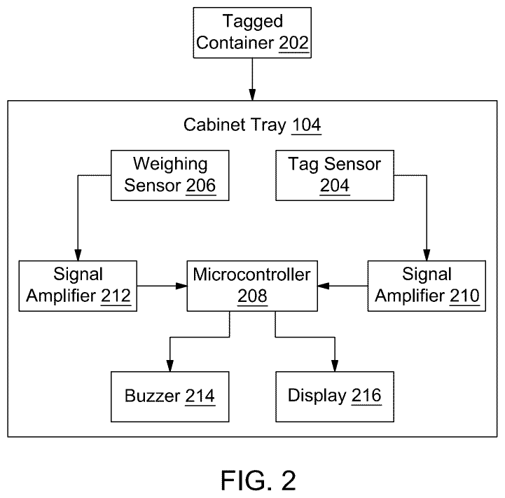

The smart cabinet system 100 may further include a cabinet tray 104. The cabinet tray 104 may include a second tag sensor and a weighing sensor. By way of an example, the second tag sensor may be, but may not be limited to, an RFID antenna, a NFC sensor, a barcode scanner, a QR code sensor, and the like. The weighing sensor may be a strain gauge sensor, a PU foam layer, a polyimide material with copper conductive layer, and the like. The second tag sensor may be configured to identify the registered tagged container 112. The weighing sensor may be configured to determine the weight of the item present in the registered tagged container 112. This is further explained in detail in conjunction with FIGS. 2-8.

In continuation with the above scenario, the user may place the registered tagged container 112 on a scanning area of the cabinet tray 104 for the identification. The second tag sensor may be configured to generate a second identification data signal the registered tagged container 112 by scanning the identification tag from the bottom surface. The second identification data signal may be sent to the server 106 through the communication network 110. The server 106 may identify the registered tagged container 112 based on the second identification data signal. Further, the registered tagged container 112 may be placed on a resting base of the cabinet tray 104 by the user. The server 106 may determine a current weight of the registered tagged container 112 (and therefore, a current quantity of the item in the registered tagged container 112). The server 106 may be further configured to determine time remaining from the expiration date of the item based on the expiration date of the item.

The server 106 may be further configured to render real-time item information to a Graphical User Interface (GUI) on the user device 108 through the communication network 110. The real-time item information may include, for example, item name, the current quantity of the item, the time remaining from the expiration date of the item, and the like. The user device 108 may be, for example, a smartphone, mobile, notebook, netbook, computer, tablet, laptop, desktop, and the like.

Referring now to FIG. 2, illustrates a functional block diagram 200 of the cabinet tray 104, in accordance with some embodiments of the present disclosure. FIG. 2 is explained in conjunction with FIG. 1. A tagged container 202 (analogous to the tagged container 112) may be placed on various sections on a top surface of the cabinet tray 104. The cabinet tray 104 may include a tag sensor 204, a weighing sensor 206, a microcontroller 208, a signal amplifier 210, a signal amplifier 212, a buzzer 214, and a display 216. The microcontroller 208 may be Wi-Fi-enabled. Additionally, the microcontroller 208 may be powered by a power supply. The microcontroller 208 with Wi-Fi capability may be, but may not be limited to, an Espressif ESP8266, an Espressif ESP32, a Microchip WFI32E01PC, a Realtek RTL8195, or the like.

The top surface of the cabinet tray 104 may include a scanning area and a resting base. The scanning area may be equipped with the tag sensor 204. The tag sensor 204 may be positioned on a bottom surface of the cabinet tray 104. When the tagged container 202 is placed on the top surface of the scanning area (above the position of the tag sensor 204), the tag sensor 204 may detect the tag attached to the tagged container 202 and may generate an identification data signal corresponding to the tagged container 204. In an embodiment, the scanning area may include a plurality of tag sensors like the tag sensor 204. In such an embodiment, a plurality of tagged containers may be identified simultaneously through the plurality of tag sensors.

Further, upon generation of the identification data signal, the signal amplifier 210 may amplify the identification data signal. Further, the signal amplifier 210 may transmit the identification data signal to the microcontroller 208. The microcontroller 208 may transmit the identification data signal to the server 106 through Wi-Fi. The server 106 may then identify the tagged container 202 through the registration details stored in a database. Additionally, the server 106 may determine time remaining from the expiration date of the item based on the expiration date of the item.

The resting base of the cabinet tray 104 may be equipped with the weighing sensor 206. The weighing sensor 206 may be positioned on a bottom surface of the resting base. When the identified tagged container 202 is placed on the top surface of the resting base (above the position of the weighing sensor 206), the weighing sensor 206 may generate current weight data signal corresponding to the identified tagged container 204. In an embodiment, the resting base may include a plurality of weighing sensors like the weighing sensor 206. In such an embodiment, a plurality of tagged containers may be weighed simultaneously through the plurality of weighing sensors.

Further, upon generation of the current weight data signal, the signal amplifier 212 may amplify the current weight data signal. Further, the signal amplifier 212 may transmit the current weight data signal to the microcontroller 208. The microcontroller 208 may transmit the current weight data signal to the server 106 through Wi-Fi. The server 106 may then determine a current quantity of the item within the tagged container 202. To determine the current quantity of the item, the server 106 may retrieve an empty container weight corresponding to the tagged container 202 from the database. Further, the server 106 may determine an initial container weight of the tagged container 202. The initial container weight is a sum of the empty container weight and the predefined initial weight of the item. The server 106 may determine a current container weight of the tagged container 202 based on the current weight data signal. The server 106 may compare the current container weight with the initial container weight to obtain the current quantity of the item within the tagged container 202.

In an embodiment, the microcontroller 208 may compile the identification signal and the current weight data signal corresponding to the tagged container 202 into a packet with an associated timestamp. Further, the microcontroller 208 may transmit the packet to the server 106 for further processing as explained above.

Upon processing the identification signal and the current weight data signal, the server 106 may render real-time item information through a GUI on a user device. The real-time item information may include the item name, the current quantity of the item, and the time remaining from the expiration date of the item. The server 106 may update the real-time information periodically and present the real-time information on the user device. Further, the server 106 may generate notifications on the user device for various events, such as when the time remaining from the expiration date is below a predefined threshold (e.g., 1 month, 1 week, 1 day, etc.). The server 106 may also generate a notification when the current quantity of the item within the tagged container 202 is below a predefined threshold (e.g., less than half the initial weight of the item).

The display 216 may be, for example, a Liquid Crystal Display (LCD), Light-Emitting Diode (LED) Display, Organic Light-Emitting Diode (OLED) Display, Active Matrix OLED (AMOLED) Display, Plasma Display Panel (PDP) Display, and the like. In an embodiment, the display 216 may be a touch screen display, where a GUI may be presented on the display 216. The GUI may provide real-time item information corresponding to the item stored in the tagged container 202. The real-time item information may include, for example, weight of the item (in grams (g) or kilograms (kg)), registration details of the tagged container 202, etc.

The buzzer 214 may be, for example, a piezoelectric buzzer, a magnetic buzzer, electromagnetic buzzer, and the like. The buzzer 214 may be configured to generate an audio signal (e.g., a beep sound, two beep sounds, etc.) or a haptic signal (e.g., vibration) to notify the user about a current quantity of the item kept in the tagged container 202. For example, the buzzer 214 may generate the audio signal when the current quantity of the item is low (i.e., below a predefined threshold quantity).

Further, the cabinet tray 104 may include a power conditioning unit (not shown in the figure). The power conditioning unit may be powered by an Alternating Current (AC) power plug. The power conditioning unit may condition the received power based on requirements of the various modules 204-216 of the cabinet tray 104 and may then supply the conditioned power to the various modules 204-216 of the cabinet tray 104.

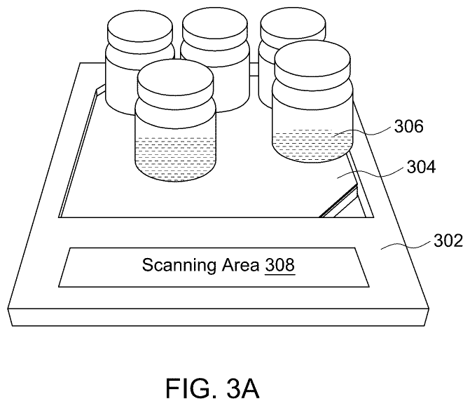

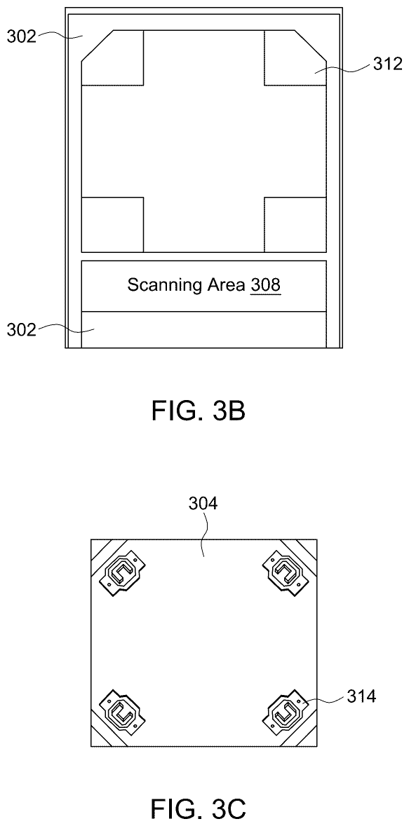

Referring now to FIGS. 3A-C, various views of an exemplary cabinet tray 302 are illustrated, in accordance with some embodiments of the present disclosure. FIGS. 3A-C are explained in conjunction with FIGS. 1 and 2. In FIG. 3A, a cabinet tray 302 may be analogous to the cabinet tray 104. The cabinet tray 302 may include a resting base 304. The resting base 304 may be defined on the top surface of the cabinet tray 302. The resting base 304 may be a plane surface present on the top surface of the cabinet tray 302 where an RFID-tagged container 306 (analogous to the tagged container 202) may be placed. The RFID-tagged container 306 may include an RFID tag attached on the bottom surface of the RFID-tagged container 306.

The cabinet tray 302 may further include a scanning area 308. The scanning area 308 may be equipped with a network of RFID antennae (analogous to the tag sensor 204). The network of RFID antennae may include one or more RFID antennae. An RFID antenna may be configured to identify the RFID-tagged container 306 when the RFID-tagged container 306 is placed on the resting base 304. There may be more than one RFID-tagged container placed on the resting base 304. In an embodiment, maximum number of RFID-tagged containers that can be placed on the resting base 304 may be defined based on area of the resting base 304. In another embodiment, the maximum number of RFID-tagged containers that can be placed on the resting base 304 may be equal to a number of weighing sensors (e.g., strain gauge sensors) in the cabinet tray 302. The strain gauge sensors (analogous to the weighing sensor 206) may be positioned below the resting base 304.

Thus, a plurality of RFID tagged containers, including the RFID-tagged container 306, may be placed on the resting base 304. When the RFID-tagged container 306 may be placed on the resting base 304, the strain gauge sensors may generate a current weight data signal to determine the current weight of the RFID-tagged container 306.

In FIG. 3B, a top view of the cabinet tray 302 with the resting base 304 removed is illustrated. The cabinet tray 302 may include an outer structure 310. The outer structure 310 may provide physical strength and protection to internal components of the cabinet tray 302. The outer structure 302 may be fragmented to create a cutout region for holding the resting base 304. The cabinet tray 302 may further include a set of support flanges 312. Each of the set of flanges 312 may be placed in the cutout region created for the resting base 204. In an embodiment, the set of flanges 312 may include 4 flanges, each placed in a corner of the cutout region. The resting base 304 may be placed on the set of flanges 312.

The cabinet tray 302 may further include internal components such as a microcontroller (analogous to the microcontroller 208), signal amplifiers associated with the RFID antennae and the strain gauge sensors (analogous to the signal amplifier 210 and the signal amplifier 212, respectively), a buzzer (analogous to the buzzer 214), and a display (analogous to the display 216). The internal components may be present within the cabinet tray 302.

In FIG. 3C, a bottom view of the cabinet tray 302 is illustrated. A bottom surface of the resting base 304 of the cabinet tray 302 may include a network of strain gauge sensors. The network of strain gauge sensors may include one or more strain gauge sensors (e.g., a strain gauge sensor 314). The network of strain gauge sensors may be arranged below the surface of the resting base 304 at each corner of the resting base 304. The network of strain gauge sensors may be connected in a Wheatstone bridge pattern. The strain gauge sensor 314 is a device that converts mechanical deformation, such as elongation, compression, stress, etc., into an electrical signal, thereby, generating the current weight data signal. The network of strain gauge sensors may be configured to generate the current weight data signal corresponding to the RFID-tagged container 306. It should be noted that the network of strain gauge sensors may be activated to generate the current weight data signal when the RFID antennae in the scanning area 308 may successfully identify the RFID-tagged container 306. Then, when the RFID tagged container 306 is placed on the resting base 304, the network of strain gauge sensors resets to zero, delays for couple of seconds, and then sends the current weight data signal to the microcontroller 208.

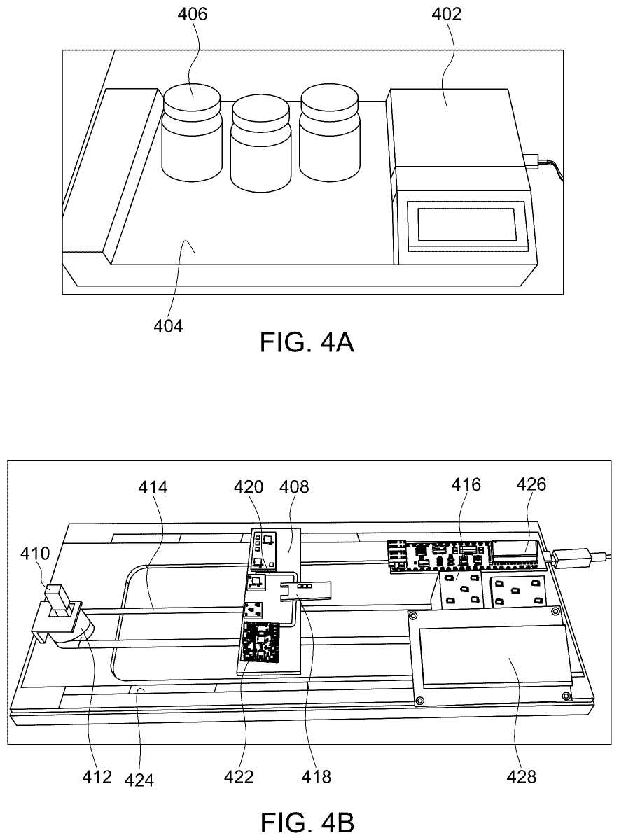

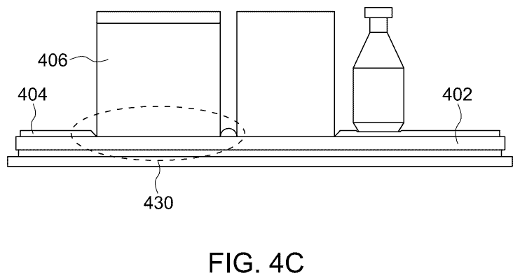

Referring now to FIGS. 4A and 4B, various views of another exemplary cabinet tray 402 is illustrated, in accordance with some embodiments of the present disclosure. FIGS. 4A and 4B are explained in conjunction with FIGS. 1, 2, and 3A-C. The cabinet tray 402 may be analogous to cabinet tray 104. In FIG. 4A, a perspective view of the cabinet tray 402 is shown. The cabinet tray 402 may include a Polyurethane (PU) foam layer 404. The PU foam layer 404 may be present on the top surface of the cabinet tray 402. A plurality of Near Field Communication (NFC) neodymium magnet-tagged containers (such as an NFC neodymium magnet-tagged container 406) may be placed on a top surface of the PU foam layer 404 of the cabinet tray 402. The cabinet tray 402 may be configured to detect a positional area of the NFC neodymium magnet tagged container 406. The cabinet tray 402 may be further configured to identify the NFC neodymium magnet-tagged container 406 placed on the PU foam layer 404. Further, the cabinet tray 402 may be configured to determine the weight of the NFC neodymium magnet-tagged container 406. This is further explained in detail in conjunction with FIGS. 4B and 4C.

In FIG. 4B, a perspective view of interior of the cabinet tray 402 is shown. The cabinet tray 402 may include various components such as a sensor platform 408, a geared micro motor 410, a timing pulley 412, a timing belt 414, a rotor encoder module 416, a magnetic field sensor 418, an RFID antenna 420, a slave microcontroller system 422, nichrome strips 424, a master microcontroller 426, and a display 428. The sensor platform 408 may include the magnetic field sensor 418, the RFID antenna 420, and the Bluetooth®-enabled slave microcontroller system 422.

The geared micro motor 410 may be, for example, Micro DC gear motor, Miniature Brushless DC motor, Micro Planetary gear motor, and the like. The geared micro motor 410 may be present at one end of the cabinet tray 402. The cabinet tray 402 may further include a timing belt pulley system driven by the geared micro motor 410. The timing belt pulley system may include the timing pulley 412 and the timing belt 414. The sensor platform 408 may move with incremental steps with the help of the geared micro motor 410 driven timing belt pulley system. The incremental steps may be controlled by the rotary encoder module 416. The rotary encoder module 416 may be connected to the timing belt pulley system via another timing pulley. The sensor platform 408 may move beneath the cabinet tray 402 to record positional data of the NFC neodymium magnet-tagged container 406.

The cabinet tray 402 may further include strips of high resistance electric heating alloy, for example, the nichrome strips 424, nickel chromium alloy ribbon, and the like. In some embodiment, electric power of 5 Volts may be supplied to the sensor platform 408 via the nichrome strips 424. The sensor platform 408 may slide in a linear motion using the motor-driven timing belt pulley system.

The cabinet tray 402 may further include a master microcontroller 426. The master microcontroller 426 may be configured to receive a first data packet from the slave microcontroller 422. The first data packet may include identity of the NFC neodymium magnet tagged container 406 and the current weight of the NFC neodymium magnet tagged container 406. The master microcontroller 426 may further be configured to merge positional data received from the rotary encoder 416 with the first data packet obtained from the slave microcontroller 422 to obtain a second data packet. Further, the master microcontroller 426 may be configured to send the second data packet to the server 106 for further processing.

The master microcontroller 426 may be further configured to control the operation of the geared micro motor 410 and operation of the display 428. The display 428 may be analogous to the display 216. The display 428 may show summary values (e.g., time left from the expiration date of the item or current quantity of the item in the container) of each of a plurality of NFC neodymium magnet-tagged containers detected in one cycle.

Referring now to FIG. 4C, a mechanism to determine the weight of the tagged container using the cabinet tray 402. FIG. 4C is explained in conjunction with FIGS. 1, 2, 3A-C, 4A, and 4B. The NFC neodymium magnet tagged-container 406, when placed on the top surface of the PU foam layer 404 of the cabinet tray 402, may cause a proportional depression 430 (i.e. tension) on the PU foam layer 404. Generation of the proportional depression 430 on the PU foam layer 404 may cause a distance variation between the NFC neodymium magnet-tagged container 406 and the magnetic field sensor 418.

Further, the distance variation may cause a variation in magnetic strength. The variation in the magnetic strength may be detected by the magnetic field sensor 418. The data of the variation in the magnetic strength may be sent to the slave microcontroller 422. The slave microcontroller 422 may be further configured to convert the mechanical depression into a current weight data signal (a numerical value) and determine a current weight of the NFC neodymium magnet-tagged container 406. The slave microcontroller 422 may then transmit the current weight to the master microcontroller 426. The master microcontroller 426 may update the current weight of the NFC neodymium magnet-tagged container 406. Additionally, the master microcontroller 426 may render the current weight of the NFC neodymium magnet-tagged container 406 on the display 428.

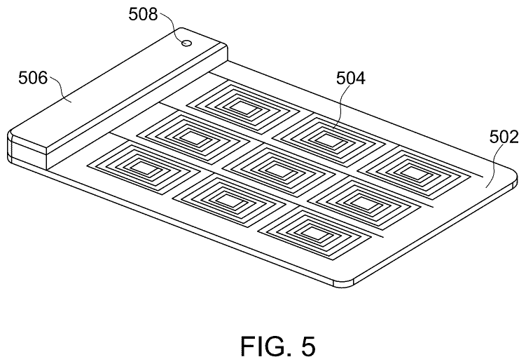

Referring now to FIG. 5, yet another exemplary cabinet tray 502 is illustrated, in accordance with some embodiments of the present disclosure. FIG. 5 is explained in conjunction with FIGS. 1, 2, 3A-C, and 4A-C. The cabinet tray 502 may be analogous to the cabinet tray 104. The cabinet tray 502 may be in form of a flexible base tray. The cabinet tray 502 may be built of a polyimide material. The polyimide material may be, for example, Polyethene (PE), Polypropene (PP), Polyvinyl Chloride (PVC), Teflon, Nylon, and the like. The cabinet tray 502 may include a conductive layer. The conductive layer may be made of a conductive material, for example, copper, silver, aluminum, and the like. The conductive layer may be etched with multiple RF antenna 504. The RF antenna 504 may be configured to identify an RFID-tagged container placed on the cabinet tray 502. The etched RF antenna 504 may be routed to a single female electrical connector. The etched RF antenna 504 may send the identification signals corresponding to the RFID-tagged container to a control module block 506 (containing components of the cabinet tray explained in conjunction with FIG. 2) through the single female electrical connector. By way of an example, the female electrical connector may be, but may not be limited to, Japan Solderless Terminal (JST) connector, SM connector, RYC connector, SHD connector, GH connector, and the like. The control module block 506 may include the microcontroller 208, the signal amplifier 210, the signal amplifier 212, the power conditioning unit, and the other peripherals. The identification signals received via an interfacing of a male electrical connector of the control module block 506 with the female electrical connector of the flexible cabinet tray 502 may then be amplified, processed, and sent to the microcontroller 208 for sampling and transmission to the server 106. The control unit 506 may receive power from a plug point 508 (i.e., 5 Volts).

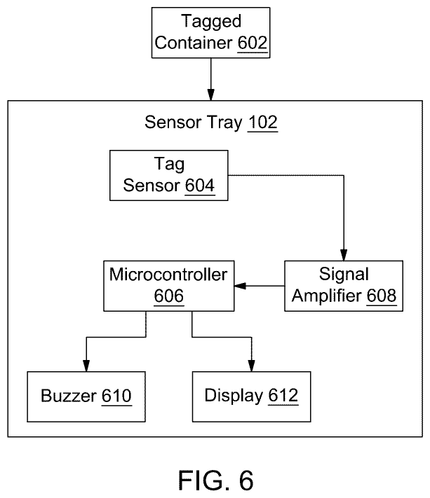

Referring now to FIG. 6, a functional block diagram the exemplary sensor tray 102 is illustrated, in accordance with some embodiments of the present disclosure. FIG. 6 is explained in conjunction with FIGS. 1, 2, 3A-C, 4A-C, and 5. The sensor tray 102 may be configured to identify and register a tagged container 602 (analogous to the tagged container 112). The sensor tray 102 may include a tag sensor 604, a microcontroller 606, a signal amplifier 608, a buzzer 610, and a display 612. In an embodiment, the tag sensor 604 and the signal amplifier 608 of the sensor tray 102 may be analogous to the tag sensor 204 and the signal amplifier 210 of the cabinet tray 104, respectively. The microcontroller 606 may be Wi-Fi-enabled. Additionally, the microcontroller 606 may be powered by a power supply. The microcontroller 606 with Wi-Fi capability may be, but may not be limited to, an Espressif ESP8266, an Espressif ESP32, a Microchip WFI32E01PC, a Realtek RTL8195, and the like.

The tagged container 602 may include an identification tag. The identification tag may be one of an RFID tag, an NFC neodymium magnet tag, a barcode tag, or a QR code tag. Further, the tag sensor 604 may be one of an RFID antenna when the identification tag is the RFID tag, an NFC sensor when the identification tag is the NFC neodymium magnet tag, a barcode scanner when the identification tag is the barcode tag, or a QR code sensor when the identification tag is the QR code.

The tag sensor 604 may be configured to generate an identification data signal corresponding to the tagged container 602. The signal amplifier 608 may amplify the identification data signal. Further, the signal amplifier 608 may transmit the identification data signal to the microcontroller 606. The microcontroller 606 may transmit the identification data signal to the server 106 through Wi-Fi.

Upon receiving the identification data signal, the server 106 may store registration details of the tagged container 602 based on the identification data signal to obtain a registered tagged container 602. The registration details may include, but may not be limited to, item name, expiration date of the item, and the predefined initial weight of the item. Additionally, the server 106 may determine the time remaining from the expiration date of the item based on the expiration date of the item.

Optionally, the sensor tray 102 may also include weighing sensors (analogous to the weighing sensor 206 of the cabinet tray 104) and corresponding signal amplifiers (analogous to the signal amplifier 212). In such an embodiment, the sensor tray 102, along with identifying and registering the tagged container 602, may also generate the current weight data signal corresponding to the tagged container 602.

Further, the microcontroller 606 may be configured to compile both the identification data signal and the current weight data signal into a data packet. Further the microcontroller 606 may transmit the data packet with an associated timestamp to the server 106 for further processing.

In an embodiment, the tray assembly may include the sensor tray 102 and the cabinet tray 104 joined together. In yet another embodiment, the tray assembly may include a single tray. In such an embodiment, the sensor tray 102 and the cabinet tray 104 may be a single entity instead of two separate entities. Here, the tray assembly may be configured to function as both the sensor tray 102 and the cabinet tray 104.

Further, the display 612 may include, for example, a Liquid Crystal Display (LCD), Light-Emitting Diode (LED) Display, Organic Light-Emitting Diode (OLED) Display, Active Matrix OLED (AMOLED) Display, Plasma Display Panel (PDP) Display, and the like. In an embodiment, the display 612 may be a touch screen and may present a GUI rendered by the server 106. The display 612 may be configured to display the real-time item information associated with the tagged container 602. The real-time information may include, for example, registration details of the tagged container (e.g., tag number, item name, expiration date of the item, and predefined initial weight of the item) and, optionally, the current quantity of the item kept in the tagged container 602.

The buzzer 610 may be, for example, a piezoelectric buzzer, a magnetic buzzer, electromagnetic buzzer, and the like. The buzzer 610 may be configured to notify the user about an unsuccessful registration of the tagged container 602. For example, if the tagged container 602 is not identified by the tag sensor 604, the buzzer 610 may generate a first notification signal (for example, one or more beep sounds, vibrations, etc.) corresponding to the unsuccessful registration. Additionally, the buzzer 610 may be configured to notify the user about a successful registration of the tagged container 602. For example, if the tagged container 602 is identified by the tag sensor 604, the buzzer 610 may generate a second notification signal (for example, one or more beep sounds, vibrations, etc.) corresponding to the successful registration.

Further, the sensor tray 102 may include a power conditioning unit (not shown in figure). The power conditioning unit may include, for example, Alternate Current (AC) supply or Direct Current (DC) Supply. By way of an example, the power conditioning unit may use AC supply. The power conditioning unit may be configured to provide power supply to components of the sensor tray 102 (i.e., the microcontroller 606, the tag sensor 604, the signal amplifier 608, the weighing sensor and corresponding signal amplifier, the display 612, the buzzer 610, and the like) based on power requirements of such components.

Additionally, the sensor tray 102 may further include a battery pack. The battery pack may be a set of any number of identical batteries or individual battery cells. The battery pack may be configured in series, parallel, or a mixture of both to deliver desired voltage or current to the power conditioning unit.

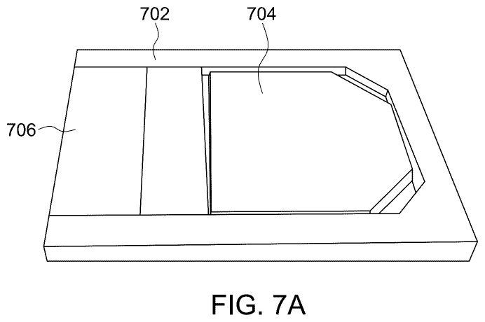

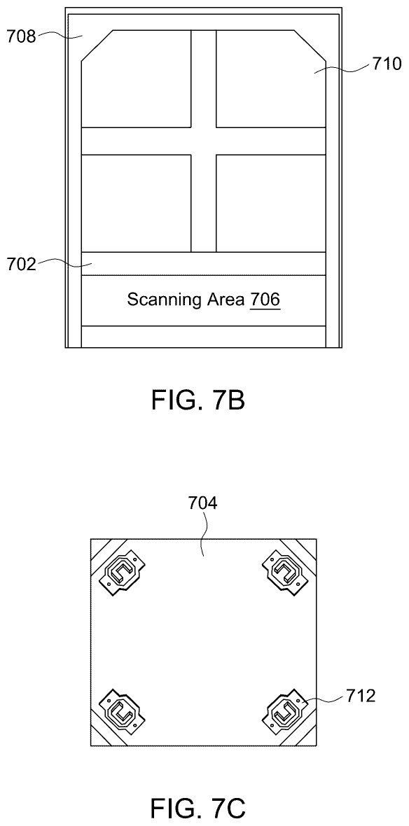

Referring now to FIGS. 7A-C, various views of an exemplary sensor tray 702 are illustrated, in accordance with some embodiments of the present disclosure. In FIG. 7A, a perspective view of the sensor tray 702 is shown. The sensor tray 702 may be analogous to the sensor tray 102. The sensor tray 702 may include a resting base 704 and a scanning area 706. The resting base 704 may be analogous to resting base 304 and the scanning area may be analogous to the scanning area 308. The scanning area 706 may be equipped with one or more RFID antennae. The one or more RFID antennae may be configured to generate an identification data signal corresponding to an RFID-tagged container (such as the tagged container 602). The resting base 704 and the scanning area 706 may be present on top surface of the sensor tray 702. The sensor tray 702 may be configured to identify and register a tagged container (such as the tagged container 602) through the identification data signal with the smart cabinet system 100 for the first time. By way of an example, the registration details may include, but may not be limited to, name of the item kept in the tagged container, expiry date of the item kept in the tagged container, and the like. In an embodiment, a plurality of tagged containers may be placed on the scanning area 706. In such an embodiment, each of the plurality of tagged containers may be identified and registered simultaneously.

In FIG. 7B, a top view of the sensor tray 702 with the resting base 704 removed is illustrated. The sensor tray 702 may include an outer structure 708. The outer structure 708 may be configured to provide strength and protection to internal components of the sensor tray 702. The outer structure 1002 may be fragmented to create a cutout region for holding the resting base 704. The sensor tray 702 may be further include a set of support flanges 710. Each of the set of support flanges 710 may be placed in the cutout region created for the resting base 704. In an embodiment, the set of flanges 710 may include 4 flanges, each placed in a corner of the cutout region. The resting base 704 may be placed on the set of flanges 710.

The sensor tray 702 may further include internal components such as internal components such as a microcontroller (analogous to the microcontroller 606), signal amplifiers associated with the RFID antennae (analogous to the signal amplifier 608), a buzzer (analogous to the buzzer 610), and a display (analogous to the display 612). The internal components may be present within the sensor tray 702.

In FIG. 7C, a bottom view of the sensor tray 702 is illustrated. A bottom surface of the resting base 704 may optionally include a network of strain gauge sensors (e.g., a strain gauge sensor 712). The strain gauge sensor 712 may be configured to generate the current weight data signal corresponding to the RFID-tagged container similar to the strain gauge sensor 314.

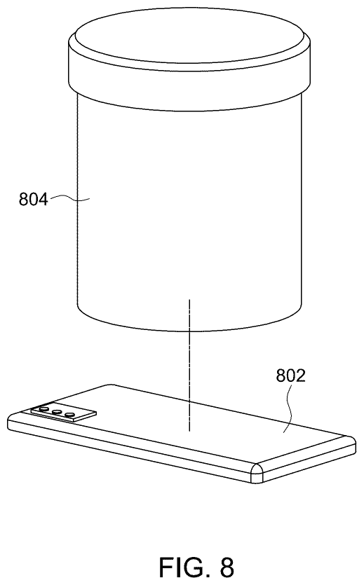

Referring now to FIG. 8, another exemplary sensor tray 802 is illustrated, in accordance with some embodiments of the present disclosure. FIG. 8 is explained in conjunction with FIGS. 1, 2, 3A-C, 4A-C, 5, 6, and 7A-C. The sensor tray 802 may be analogous to the sensor tray 102. In some embodiments, the user device 108 may be configured function as the sensor tray 802. For example, the sensor tray 802 may be an NFC-enabled smart phone. The sensor tray 802 may be configured to identify an NFC-tagged container 804. Upon identifying the NFC-tagged container 804, the registration details (i.e. name of the item kept in the tagged container, expiry date of the item, registration number, tag number and the like) of the NFC-tagged container 804 may be transmitted to the server 106. The server 106 may then store the registration details in a database.

It should be noted that that the sensor tray 802 may also be configured to identify and recognize other tagged containers such as the barcode tagged container or the QR tagged container through an in-built camera/scanner in the sensor tray 802.

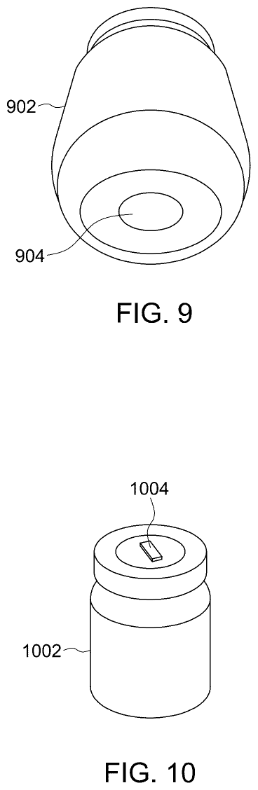

Referring now to FIG. 9, an exemplary RFID/QR-tagged container 902 is illustrated, in accordance with some embodiments of the present disclosure. FIG. 9 is explained in conjunction with FIGS. 1, 2, 3A-C, 4A-C, 5, 6, 7A-C, and 8. The RFID-tagged container 902 may include an RFID tag 904 (for example, a 127 KHz RFID tag). The RFID tag 904 may be placed at the bottom surface of the RFID-tagged container 902. The RFID-tagged container 902 may be identified through RFID antenna (i.e., RFID sensors).

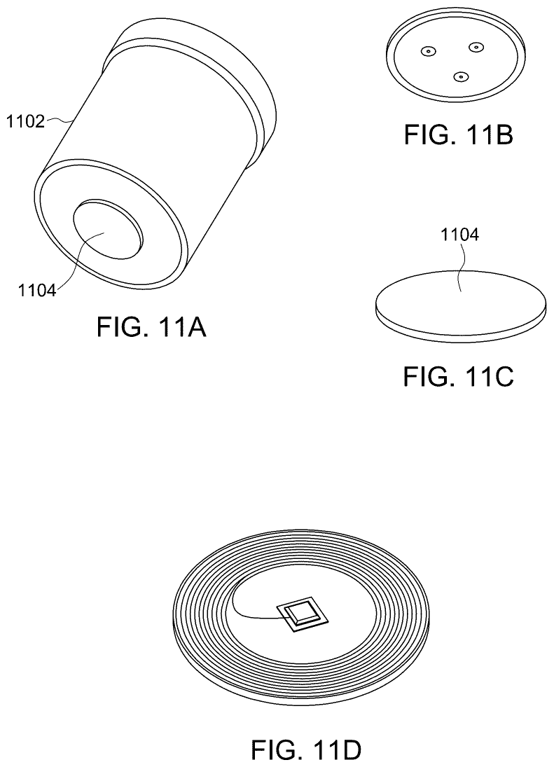

Referring now to FIG. 10, an exemplary NFC neodymium magnet-tagged container 1002 is illustrated, in accordance with some embodiments of the present disclosure. FIG. 10 is explained in conjunction with FIGS. 1, 2, 3A-C, 4A-C, 5, 6, 7A-C, 8, and 9. The NFC neodymium magnet-tagged container 1002 may include an RFID tag (e.g., a 127 KHz RFID tag) and magnet (e.g., a mini neodymium coin) 1004. The RFID tag and magnet 1004 may be positioned at bottom surface of the NFC neodymium magnet-tagged container 1002. It should be noted that, the NFC neodymium magnet-tagged container 1002 may require an NFC sensor for its scanning. The NFC neodymium magnet-tagged container 1002 may be placed on an electromechanical cabinet tray, such as the cabinet tray 402.

Referring now to FIGS. 11A-D, various views of an exemplary NFC strain-tagged container 1102 are illustrated, in accordance with some embodiments of the present disclosure. FIGS. 11A-D are explained in conjunction with FIGS. 1, 2, 3A-C, 4A-C, 5, 6, 7A-C, 8, 9, and 10. The NFC strain tagged container 1102 may include a NFC strain tag 1104. The NFC strain tag 1104 may include an outer surface 1106 and an inner surface 1108. The outer surface 1106 of the NFC strain tag 1104 may be adhesive in nature. The outer surface 1106 of the NFC strain tag 1104 may be attached below (i.e., to the bottom surface of) the NFC strain-tagged container 1102.

In FIG. 11B, a perspective view of the outer surface 1106 of the NFC strain tag 1104 is shown. The NFC strain tag 1104 may further include a set of projections 1110 on the inner surface 1108. The NFC strain tag 1104 may further include a foam layer 1112. The foam layer 1112 may be placed at the inner periphery of the NFC strain tag 1104. The foam layer 1112 may provide strength to the NFC strain tag 1104.

In FIG. 11C, a perspective view of the inner surface 1108 of the NFC strain tag 1104 is shown. The inner surface 1108 may be coated with an adhesive to enable attachment of the NFC strain tag 1104 to a container.

In FIG. 11D, an internal view of the inner surface 1108 of the NFC strain tag 1104 is shown. The NFC strain tag 1104 may be made of the polyvinyl chloride (PVC) 1114. The NFC strain tag 1104 may further include a copper wound antenna 1116, strain gauges 1118, and a microchip 1120 (i.e., a semiconductor device) at the center of the NFC strain tag 1104. The copper antenna 1116 may be wound in circular form. The strain gauges 1118 may be connected in the delta Wheatstone bridge pattern. Through the delta Wheatstone bridge pattern, data is written to the microchip 1120, when an external RFID signal (for example, from the tag sensor) powers the microchip 1120.

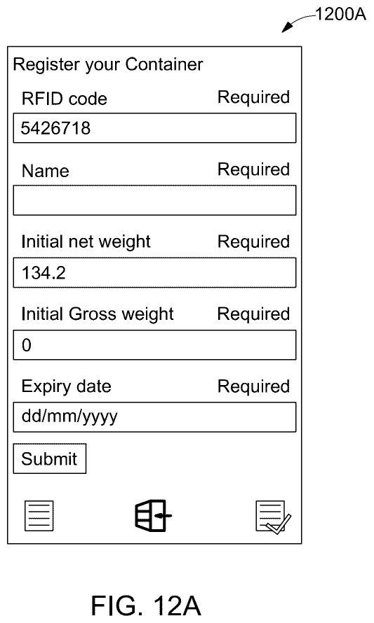

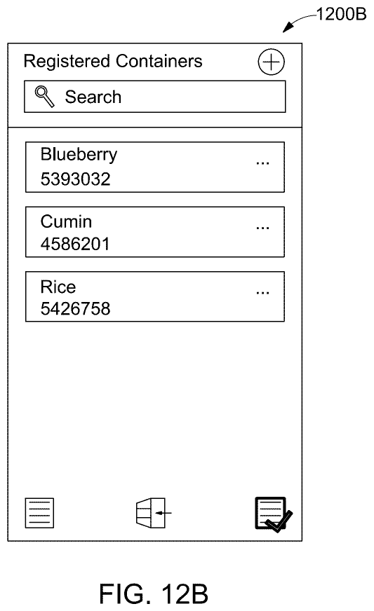

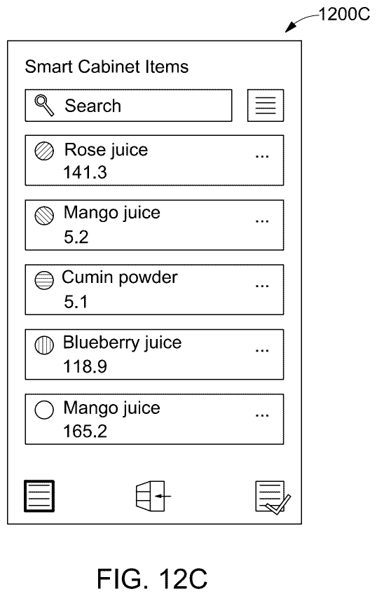

Referring now to FIGS. 12A-C, exemplary GUIs corresponding to a smart cabinet system (for example, the smart cabinet system 100) are illustrated, in accordance with some embodiments of the present disclosure. 12A-C are explained in conjunction with FIGS. 1, 2, 3A-C, 4A-C, 5, 6, 7A-C, 8, 9, 10, and 11A-D. In FIG. 12A, a GUI 1200A is rendered on the user device 108 when the sensor tray 102 sends an identification data signal corresponding to the tagged container 112 to the server 106. An RFID code is auto-populated in the GUI 1200A by the server 106 based on the identification data signal. Name of the item is a mandatory field to be filled by the user. Initial net weight may be a difference between the weight of the tagged container with the item and the weight of an empty tagged container. The initial net weight may be either determined by a weighing sensor on the sensor tray 102 or manually entered by the user. Initial gross weight may be a combined weight of the tagged container with the item and the weight of an empty tagged container.

Expiry date of the item may be manually entered or extracted from item packaging using a Computer Vision (CV) technique. Upon entering each of the required fields, the user may hit on “submit” button.

In FIG. 12B, a GUI 1200B is rendered on the user device 108 to display a list of registered tagged containers. Upon successful registration of the tagged container 112, the GUI 1200B may display item name of the item in the tagged container 112 and tag information (e.g., RFID code) of the tagged container 112.

In FIG. 12C, a GUI 1200C is rendered on the user device 108 to display real-time item information of the registered items. The corresponding quantity of each of the registered items may be updated by the server 106 based on the identification data signal and the current weight data signal received from the cabinet tray 104. For example, the registered items may include rose juice (quantity—141.3 g), mango juice (quantity—5.2 g), cumin powder (quantity—5.1 g), blueberry juice (quantity—118.9 g), and mango juice (quantity—165.2 g). The GUI 1200C may further include a search bar to search for specific items among the registered items.

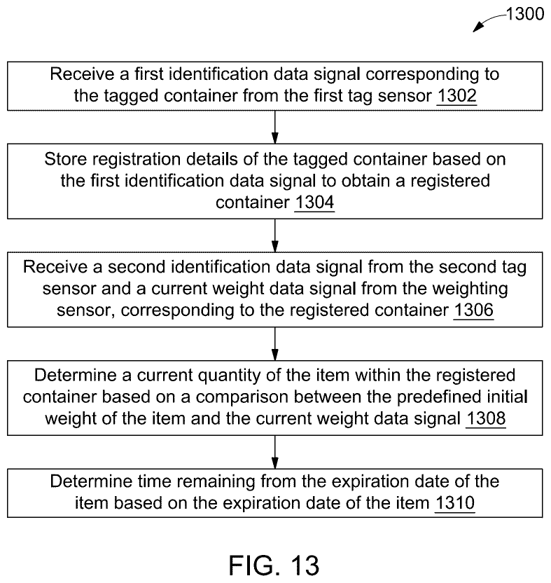

Referring now to FIG. 13, illustrates a flow diagram of an exemplary process 1500 depicting a working mechanism of the smart cabinet system 100 is illustrated via a flowchart, in accordance with some embodiments of the present disclosure. FIG. 15 is explained in conjunction with FIGS. 1, 2, 3A-C, 4A-C, 5, 6, 7A-C, 8, 9, 10, 11A-D, and 12A-C. Each step of the process 1300 may be performed by the server 106.

Initially, at step 1302, a first identification data signal corresponding to the tagged container (for example, the tagged container 112) may be received from the first tag sensor (e.g., the tag sensor 604). By way of an example, the first tag sensor may include, but is not limited to, a RFID antenna, a NFC sensor, a barcode scanner, a Quick Response (QR) code, and the like.

Upon receiving the first identification data signal from the first tag sensor, at step 1304, the registration details of the tagged container may be stored based on the first identification data signal to obtain a registered container. The registration details of the tagged container may be stored in the database. By way of an example, the registration details may include, but are not limited to, an item name, an expiration date of the item, and the predefined initial weight of the item, and the like.

Once the registration details of the tagged container are stored in the database, at step 1306, a second identification data signal may be received from the second tag sensor (e.g., the tag sensor 204) corresponding to the registered container. Furthermore, at step 1506, a current weight data signal may be received from the weighing sensor (e.g., the weighing sensor 206) corresponding to the registered container. In some embodiment, the second tag sensor may include, but is not limited to, an RFID antenna, an NFC sensor, a barcode scanner, a Quick Response (QR) code, and the like. By way of an example, the weighing sensor may include, but is not limited to, a strain gauge sensor, a PU foam layer, polyimide material with copper conductive layer, and the like.

Further, at step 1308, a current quantity of the item within the registered container may be determined based on a comparison between the predefined initial weight of the item and the current weight data signal. Initially, an empty container weight from a database may be retrieved corresponding to the registered container. By way of an example, the weight of the empty container is 20 gm. Further, an initial container weight of the registered container may be determined. It should be noted that the initial container weight is a sum of the empty container weight and the predefined initial weight of the item. In continuation with the above example, the predefined initial weight of the item (i.e. rice) is 1000 g. Then the initial container weight is the sum of empty container weight (20 g) and the predefined initial weight of the rice (1000 g). Then the initial container weight may be obtained (1020 g).

Further, a current container weight of the registered container may be determined based on the current weight data signal. In continuation with the above example, the current container weight of the registered container is (500 g). Further, the current container weight may be compared with the initial container weight to obtain the current quantity of the item within the registered container. In continuation of with the above example, the current quantity of the rice is obtained by comparing the current container weight (500 g) with the initial container weight (1020 g). The current quantity of the rice in the tagged container is (1020 g-500 g) will obtain 520 g. Finally, the user may obtain the current quantity of the rice is 520 g on its user device.

Further, at step 1310, time remaining from the expiration date of the item may be determined based on the expiration date of the item.

What is claimed is:

1. A smart cabinet system comprising:
a tagged container comprising a predefined initial weight of an item;
a tray assembly comprising:
a sensor tray comprising a first tag sensor; and
a cabinet tray comprising a second tag sensor and a weighing sensor; and
a server configured to:
receive a first identification data signal corresponding to the tagged container from the first tag sensor;
store registration details of the tagged container based on the first identification data signal to obtain a registered container, wherein the registration details comprise item name, expiration date of the item, and the predefined initial weight of the item;
receive, corresponding to the registered container:
a second identification data signal from the second tag sensor, and
a current weight data signal from the weighing sensor;
determine a current quantity of the item within the registered container based on a comparison between the predefined initial weight of the item and the current weight data signal; and
determine time remaining from the expiration date of the item based on the expiration date of the item.

2. The smart cabinet system of claim 1, wherein the server is further configured to render real-time item information through a Graphical User Interface (GUI) on a user device, wherein the real-time item information comprises the item name, the current quantity of the item, and the time remaining from the expiration date of the item.

3. The smart cabinet system of claim 1, wherein the tagged container comprises an identification tag, wherein the identification tag is one of a Radio Frequency Identification (RFID) tag, a Near-Field Communication (NFC) neodymium magnet tag, a barcode tag, or a Quick Response (QR) code tag.

4. The smart cabinet system of claim 3, wherein each of the first tag sensor and the second tag sensor is one of:
an RFID antenna when the identification tag is the RFID tag,
an NFC sensor when the identification tag is the NFC neodymium magnet tag,
a barcode scanner when the identification tag is the barcode tag, or
a QR code sensor when the identification tag is the QR code.

5. The smart cabinet system of claim 1, wherein the weighing sensor is one of a strain gauge sensor, a PU foam layer, or a polyimide material with copper conductive layer.

6. The smart cabinet system of claim 1, wherein to determine the current quantity of the item within the registered container, the server is configured to:
retrieve an empty container weight corresponding to the registered container from a database;
determine an initial container weight of the registered container, wherein the initial container weight is a sum of the empty container weight and the predefined initial weight of the item;
determine a current container weight of the registered container based on the current weight data signal; and
compare the current container weight with the initial container weight to obtain the current quantity of the item within the registered container.

7. A method implemented by a smart cabinet system, the method comprising:
receiving, by a server, a first identification data signal corresponding to a tagged container from a first tag sensor of a sensor tray, wherein:
the tagged container comprises a predefined initial weight of an item,
the sensor tray comprises the first tag sensor,
a tray assembly comprises the sensor tray and a cabinet tray, and
the cabinet tray comprises a second tag sensor and a weighing sensor;
storing, by the server, store registration details of the tagged container based on the first identification data signal to obtain a registered container, wherein the registration details comprise item name, expiration date of the item, and the predefined initial weight of the item;
receiving, by the server, a second identification data signal from the second tag sensor and a current weight data signal from the weighing sensor, corresponding to the registered container;
determining, by the server, a current quantity of the item within the registered container based on a comparison between the predefined initial weight of the item and the current weight data signal; and
determining, by the server, time remaining from the expiration date of the item based on the expiration date of the item.

8. The method of claim 7, further comprising rendering, by the server, real-time item information to a Graphical User Interface (GUI) on a user device, wherein the real-time item information comprises the item name, the current quantity of the item, and the time remaining from the expiration date of the item.

9. The method of claim 7, wherein the tagged container comprises an identification tag, wherein the identification tag is one of a Radio Frequency Identification (RFID) tag, a Near-Field Communication (NFC) neodymium magnet tag, a barcode tag, or a Quick Response (QR) code tag.

10. The method of claim 9, wherein each of the first tag sensor and the second tag sensor is one of:
an RFID antenna when the identification tag is the RFID tag,
an NFC sensor when the identification tag is the NFC neodymium magnet tag,
a barcode scanner when the identification tag is the barcode tag, or
a QR code sensor when the identification tag is the QR code.

11. The method of claim 7, wherein the weighing sensor is one of a strain gauge sensor, a PU foam layer, or a polyimide material with copper conductive layer.

12. The method of claim 7, wherein to determine a current quantity of the item within the registered container, the method comprises:
retrieving, by the server, an empty container weight corresponding to the registered container from a database;
determining, by the server, an initial container weight of the registered container, wherein the initial container weight is a sum of the empty container weight and the predefined initial weight of the item;
determining, by the server, a current container weight of the registered container based on the current weight data signal; and
comparing, by the server, the current container weight with the initial container weight to obtain the current quantity of the item within the registered container.
